(19) United States
(12) Patent Application Publication
(10) Pub. No.: US 2006/0031119 A1
(43) Pub. Date: Feb. 9, 2006

(54) Method and associated apparatus for providing digital rewards associated with physical products

(75) Inventors: Abigail Jane Sellen, Newbury (GB); Robert Francis Squibbs, Bristol (GB); Richard Anthony Lawrence, Chipping Sodbury (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT CO., L.P.

(21) Appl. No.: 11/192,368

(22) Filed: Jul. 29, 2005

(30) Foreign Application Priority Data
Jul. 30, 2004 (GB) 0417143.5

(51) Int. Cl. G06Q 30/00

(52) U.S. Cl. 705/14

(57) ABSTRACT

A method of providing a digital reward involves providing products with an attached digital memory. One digital content part from a set of digital content parties is downloaded to the digital memory of each such product. The digital content parts of the set together define the digital reward. The digital content parts of a set uploaded to a computing device are used by an application to make the digital reward available to a user of the computing device. The products may be collectable cards or game cards, or any consumer products.

### FIELD OF THE INVENTION

The invention relates to a method and associated apparatus for providing digital rewards associated with physical products.

### BACKGROUND TO THE INVENTION

A standard inducement to customers to purchase a particular product is the offer of some kind of reward—exclusive material associated with the product available free or at a discount, or more or less any other desirable content. Typically this may be a coupon attached to the product packaging, either redeemable at the retailer or to be sent to a representative of the manufacturer. Reward products are often attached directly to product packaging. In other arrangements, rewards can be obtained or competitions and lotteries entered by contacting addresses, telephone numbers or websites marked on product packaging.

Digital content—most typically music, video or computer games—is often provided as such an inducement. This is done at present by physically including a CD in the product packaging or by providing a URL or other designation of a website. Neither of these inducements operates as an incentive to keep buying the product. A known inducement to this effect is inclusion of physical tokens in product packaging which can be detached and collected, with a number of tokens being redeemable in whole or part for a gift.

It remains desirable to enrich user experience in gaining rewards for continued purchase of product to make the process of inducing continued customer purchase more effective.

### SUMMARY OF THE INVENTION

In one aspect, the invention provides a method of providing a digital reward comprising: providing products with an attached digital memory; downloading to the digital memory of each such product one digital content part from a set of digital content parts, the digital content parts of the set together defining the digital reward; providing executable code which when executed by a suitable computing device uses the digital content parts of a set uploaded to that computing device to make the digital reward available to a user of the suitable computing device.

### DESCRIPTION OF DRAWINGS

Specific embodiments of the invention will now be described, by way of example, with reference to the accompanying drawings, of which:

FIG. 1 shows a sheet of paper annotated with electronic data in a manner illustrative of an embodiment of the invention;

FIG. 2 shows an inductively powered radio frequency memory tag suitable for use in the embodiments of the invention;

FIG. 3 shows the circuitry of the memory tag of FIG. 2 and of a read/write device for wireless communication with the memory tag;

FIG. 4 illustrates a first embodiment of the invention relating to digital content stored in memory tags of a set of collectable cards;

FIG. 5 is a flow diagram illustrating a method of obtaining a reward in accordance with the first embodiment of the invention;

FIG. 6 illustrates a second embodiment of the invention relating to digital content stored in memory tags of a set of collectable cards;

FIG. 7 is a flow diagram illustrating a method of obtaining a reward in accordance with the second embodiment of the invention;

FIG. 8 shows three stages in the obtaining of a consumer product having a part of a set of digital content attached in accordance with a third embodiment of the invention;

FIGS. 9A and 9B show retailer computing apparatus for purchases of consumer product with first and subsequent digital content respectively;

FIG. 10 shows steps in purchase of consumer product with attached digital content in accordance with the third embodiment of the invention; and

FIG. 11 shows steps in the obtaining of a digital reward from digital product provided with consumer product in accordance with the third embodiment of the invention.

### DESCRIPTION OF SPECIFIC EMBODIMENTS

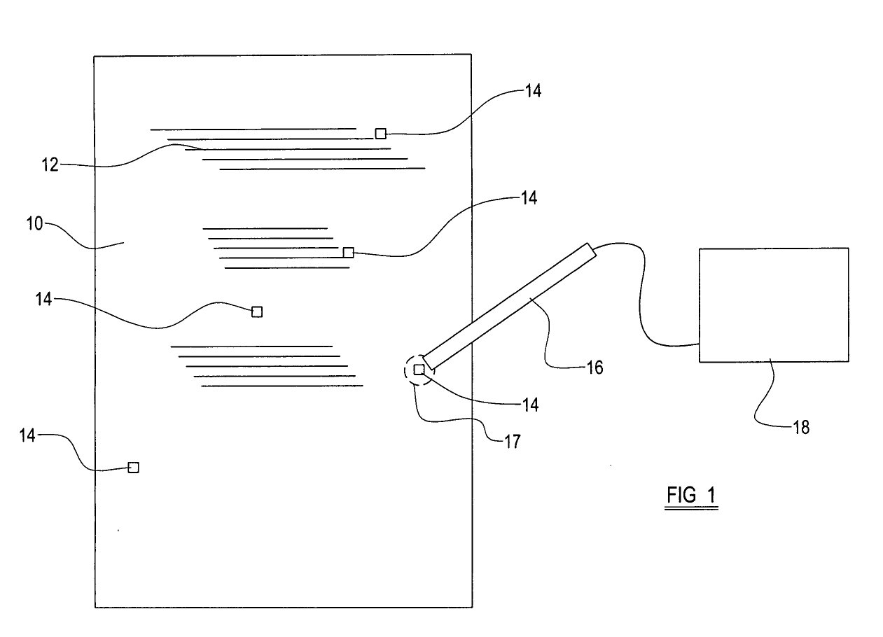

There will first be described, with reference to FIGS. 1 to 3, a particularly suitable technology for use according to embodiments of the invention by which memory circuits can be attached to or incorporated within physical products. The memory circuits described are a form of inductively powered circuit read and written by radio-frequency communication—as such they resemble the existing RFID tag—but it will be appreciated by the skilled person that alternative forms of memory circuit may also be employable for the purpose described. Such passive memory circuits, powered read and written inductively or by contact, will hereafter be termed “memory tags”. As will be discussed below, in many applications, including certain embodiments of the present invention, limitation of interaction with a memory tag to contact or near-contact has practical advantages.

FIG. 1 illustrates an item, in this case a sheet of paper 10, bearing printing 12, which has been annotated with electronic data using a plurality of memory tags 14. The memory tags 14 have been secured to the sheet of paper 10 at various locations over its surface, although they may alternatively be embedded in the paper sheet 10, preferably in locations identified by the printing 12, in order to assist in locating them for the purposes of reading data from or writing data to the memory tags 14.

A hand held read/write device 16 is used to communicate with the memory tags 14 in wireless manner, as will be discussed further below. The read/write device 16 is also connected to a host computer, display, data rendering device or other apparatus 18 from which the data for writing to the memory tags 14 is received, and/or the data read from the memory tags 14 is passed. An appropriate read/write device may indeed be integrated with a suitable computing device.

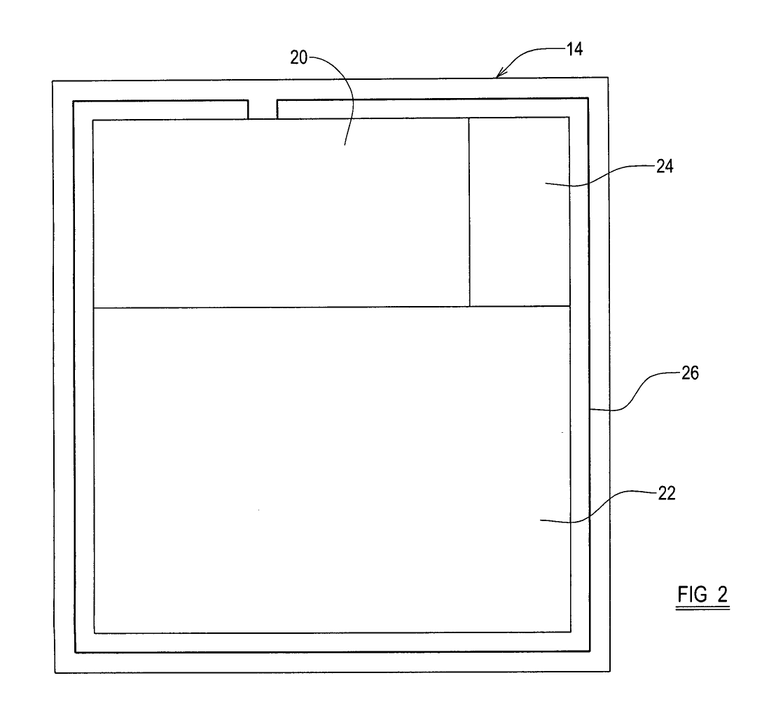

Referring now to FIG. 2, a schematic of a memory tag 14 is shown. The memory tag 14 is an RFID-like memory tag provided on a chip, and comprises an RFID-type transponder circuit 20, a memory 22, a power supply capacitor 24 and an antenna coil 26 having only a few turns e.g. five, or as in this case a single turn. The RFID-type transponder circuit 20 operates at 2.45 GHz, is of an area of approximately 0.5 mm², and will be described further below. The memory 22 provides 1 Mbit of capacity of non-volatile memory and is of an area of approximately 1 mm², and uses FRAM (ferroelectric random access memory) or MRAM (magnetoresistive random access memory) or similar memory technology requiring low power. The memory tags 14 are of a substantially square shape in plan view with an external dimension D for their sides of around 1 mm.

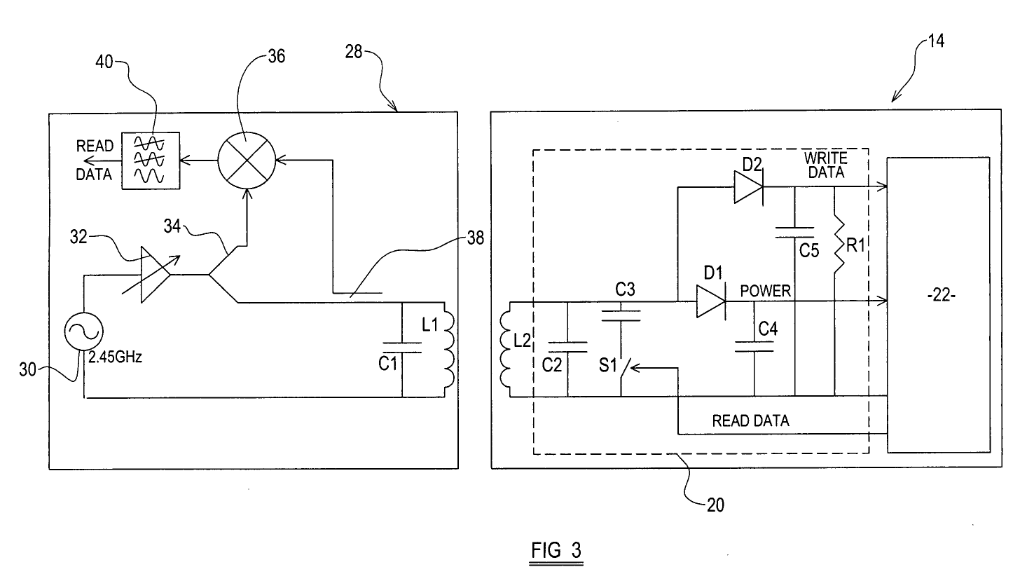

Referring now to FIG. 3, the circuitry of a memory tag 14 and circuitry 28 of the read/write device 16 are illustrated schematically, using conventional component identifications (C-capacitor, L-inductance, R-resistor, D-diode and S-switch). The RFID-type transponder circuit 20 of the memory tag 14 comprises a capacitor C2 which, in combination with the antenna coil L2 (26), forms a resonant circuit with component values being chosen to tune the combination to approximately 2.45 GHz for inductive coupling with the read/write device 16. The portion of transponder circuit 20 responsible for power supply is diode D1 and capacitor C4 (24), with diode D1 rectifying the alternating current generated by the inductive coupling and the capacitor C4 acts as a power supply storage. The portion of the transponder circuit 20 responsible for receiving transmitted data from the read/write device 16 is diode D2, capacitor C5 and resistor R1 which form a simple envelope detector; the data thus received is stored in memory 22. The portion of the transponder circuit 20 responsible for the reading of data from the memory 22 is the tuned circuit L2/C2 in combination with S1 and C3, switching C3 in and out of the circuit using S1 changes the resonance of tuned circuit L2/C2 resulting in phase modulation of the reflected power from the memory tag 14 to the read/write device 16.

The circuit 28 of the read/write device 16 comprises a signal generator 30 which generates a signal at the chosen frequency of 2.45 GHz. This signal passes via an amplitude modulator 32, where it is amplitude modulated with data to be written to the memory tag 14, and a splitter 34, to an antenna L1 and capacitor C1 which form a tuned circuit. The component values of L1 and C1 being chosen to tune it to 2.45 GHz, as for the tuned circuit in the memory tag 14, in order to maximise inductive coupling between the two circuits, and thus transmission of power and data to the memory tag 14.

The splitter 34 takes a part (as much as 50% of the power) of the amplitude modulated signal, for use as a reference signal, and passes it to a multiplier 36. The signal received from the memory tag 14, via the tuned circuit L1/C1 and divided from the outgoing signal by a coupler 38, is also passed to the multiplier 36. Thus the transmitted amplitude modulated signal and received signal are multiplied and then pass through a low pass filter 40 to provide a signal comprising the phase modulation from the memory tag 14 and thus indicative of the data read from the memory tag 14. This signal is then passed to the host computer or other device 18 to which the read/write device 16 is connected, for subsequent data processing.

One amplitude modulation format which may be used to apply the data to be transmitted to the 2.45 GHz signal is Amplitude Shift Keying (ASK) which only requires the simple envelope detector D2/C5 described in the circuit 20. However, other amplitude modulation formats may also be employed. Further alternatives are Frequency Shift Keying (FSK) and Phase Shift Keying (PSK) that provide near constant envelope modulation, that is modulation without any significant amplitude modulation, however these options have more complex demodulation requirements and thus demand more complex circuitry in the memory tag 14.

With the apparatus of memory tag 14 and read/write device 16 described above power transfer of around 25% can be achieved with a distance of around 1.8 mm between the antennae L1 and L2, of the read/write device 16 and memory tag 14 respectively. This is sufficient to transfer enough power to the memory tag 14 for it to operate.

The memory tags 14 have an external dimension D of around 1 mm, as described above, and therefore the read/write device 16 can communicate with them over a relatively short range, in this example of approximately 2D, (as illustrated on FIG. 1 by broken circle 17). However, the distance over which the read/write device 16 and memory tag 14 will communicate effectively will clearly vary with the exact details of their construction, and it may therefore be up to 10D. Use over distances greater than this would limit the ability to use a plurality of memory tags 14 on a single sheet of paper 10, or other item, due to the distances which would be necessary between the memory tags 14 to ensure that the read/write device 16 does communicate with the desired memory tag 14 out of a number present. To ensure that communication is with the correct memory tag 14 in every circumstance a communication distance of 5D or less is preferable.

The memory tags 14 will preferably have a data rate of 10 Mbitss⁻¹, which is two orders of magnitude faster than is typical in prior art devices. Such a data rate would enable the read/write device 16 to be held over the memory tag for a very short period of time (“brush and go”) for the data to be read or written as appropriate.

Although the memory tags 14 described above operate at 2.45 GHz it should be understood that memory tags operating at other frequencies may be used to implement the invention. Factors affecting the choice of operating frequency for the memory tags are: a) government regulations concerning radio frequency transmissions; b) adequate bandwidth (consistent with government regulations); c) frequency high enough to render the physical size of components in the memory tag small enough to keep the area of silicon required low (and hence the cost to manufacture low); d) frequency low enough to provide adequate performance when using low-cost high-volume CMOS technology to manufacture the memory tag.

It should further be appreciated that memory tags of this functional type can be produced without using RFID-type technology. For example, optical technologies can be used to power, read and write to memory tags, as described in GB-A-2395613.

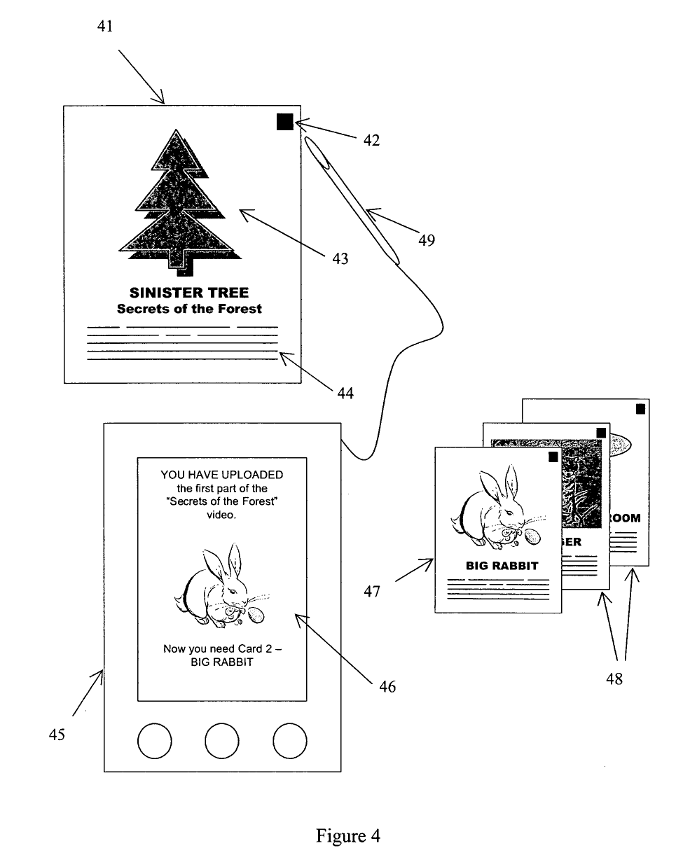

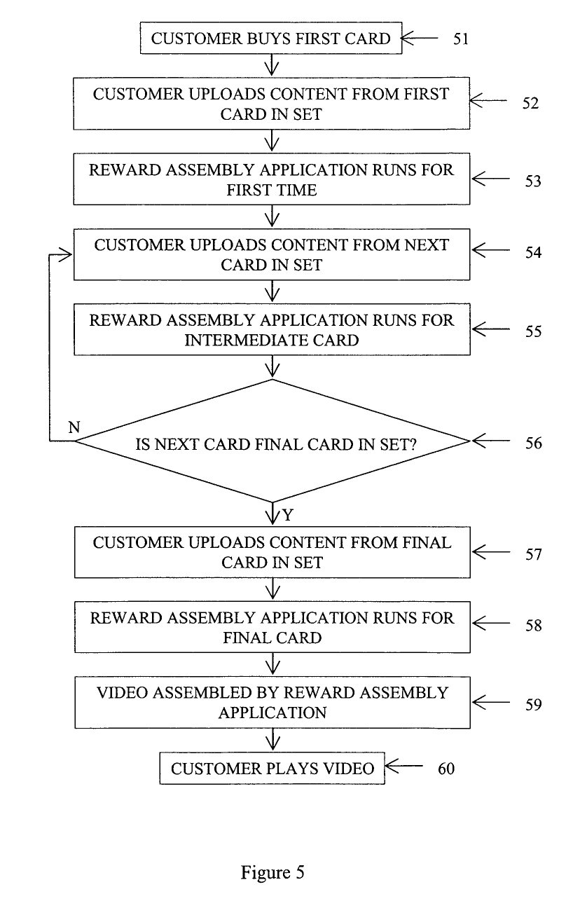

A first embodiment of the invention will now be described with reference to FIGS. 4 and 5. In this first embodiment the physical products are collectable cards. A first card 41 has an image 43 and some associated text 44, together with a memory tag 42 containing digital content. This memory tag 42—in this as in subsequent embodiments a memory tag as described above with reference to FIGS. 1 to 3, though as indicated there, other types of memory tag could be used instead—is read by reader/writer stylus 49 associated (here by wire, but this could as easily be done by an appropriate networking technology such as Bluetooth) with computing device 45, in this case a PDA. FIG. 4 shows the display 46 of PDA 45 after uploading of digital content from memory tag 42. First card 41 is the first card of a set of collectable cards, all having similar elements to first card 41. Second card 47 is here identified on display 46 as being the next required for uploading to obtain a digital reward—in this case, the means to obtain a video, “Secrets of the Forest”. The remaining cards 48 in the set are required to enable the digital reward to be obtained—in this case, simply by assembling the content from the cards in the set, which together provide all the digital content for the video.

FIG. 5 indicates the steps involved in this provision of content. The customer buys (step 51) the first card (indicated as the first of a set)—this could be either as an identified purchase, or it could come within a sealed pack of cards (for example, containing an unidentified “first card” and various unidentified “follow on cards”—this would allow cards to be swapped between customers, in a manner frequently adopted for collectables, to allow a customer access to a desired second card). The customer then uploads (step 52) from the card to his computing device—which may be for example (and without limitation) a PC, a PDA or even a cellular telephone—the digital content stored in its memory tag 42. For a first card, this contains an application which runs (step 53) when uploaded to the computing device, indicating the nature of the reward and the next member of the set of cards. The remainder of the content uploaded from the first card is a first part of the digital reward. The next task for the user is to obtain the second card in the set and to upload (step 54) the digital content from its memory tag. This upload invokes (step 55) the application uploaded from the first card, which indicates the next card of the set. Again, the uploaded digital content contains a part of the digital reward. The way to proceed (step 56) after this depends on whether the next card is to be the final card—the preceding steps repeated for any further intermediate cards in the set, until the customer is prompted to obtain the final card. Upon obtaining and uploading (step 57) digital content from the final card of the set, the application is again invoked (step 58), upon which it notifies the user that the set is complete and that the digital reward is now obtainable. The application also assembles (step 59) the digital reward from the digital content parts provided in the upload from each card according to a pattern indicated within the application. In this case, the digital reward is itself the video indicated in the message provided on the display of the PDA—the result of assembly by the application is the video provided in an appropriate file format in the file structure of the PDA, together with an indication of how to play the file on the PDA display. The customer plays (step 60) the video on the PDA by following this indication.

There are a number of different ways in which content could be assembled on being provided in parts in separate memory tags in this way. The assembly application could, for example, be resident on the PDA rather than provided on the first card, and may need to be invoked before uploading of content from any of the cards. Such an application could be a general loader of content provided in this form—in which case the content provided by the first card (and subsequent cards) need contain no applications, but instead content of two different basic types—content to provide the application with necessary information relating to the specific card and the set of cards, and content forming part of the digital reward. The first type of content will include information to allow the application to identify each member of the set, to allow content to be collected from each member of the set and stored appropriately, and to provide appropriate content for display to the user in respect of the state of reward collection, nature of the reward and identification of the next card to collect.

A second embodiment of the invention will now be described with reference to FIG. 6 and to FIG. 7. This arrangement also relates to collectable cards, but differs from the first embodiment in that there is no designated first card in a set, and in that the digital reward is of indirect rather than direct benefit to the customer, as it enables the customer to obtain a directly valuable award (allowing the provider direct control over the provision of the directly valuable reward—this may be particularly valuable in respect of digital media content).

FIG. 6 shows a collectable card 61 first bought (or otherwise obtained) by the customer (step 71 of FIG. 7). This card resembles the cards of FIG. 4, in that it has a representative image 63 and text 64 together with a memory tag 64. There is now no designated “first card” in a set of cards—each card contains in its memory tag a copy of the reward assembly application together with card content. The card content is of two types: the digital content that forms a part of the digital reward, together with content that relates to the display to be provided to the user on uploading of the card content. When the customer uploads digital content (step 72) from this first obtained card 61 to his computing device (in this example, PDA 65), the reward assembly application which has been uploaded begins to run (step 73). The application first establishes that no other card content from the set of cards has been uploaded, and it establishes an appropriate file structure for the content uploaded from this card (and from any further cards in the set). The application then uses the user display related content from the uploaded card to generate the user content (step 74)—in this case, a clue to the next card in the set displayed on the display 66 of the PDA 65. A number of approaches are available to providing such clues. In the present example, each card can be considered as a node with all the nodes of the set connected in a ring. Uploading of digital content from one card causes a clue to be generated to direct the customer to the card forming the next node in the ring, this process continuing until all the nodes have been visited and hence all card content uploaded. In this case, the uploading of one card will always lead to provision of a clue for a determined next card (as here, where first bought card 61 will always provide the clue for succeeding card 67). However, clues may be provided which give the customer the option to next upload not only a specific one but one of several, or one of all, of the remaining cards in the set. In this case the clue provided may not be determined by the last content to be uploaded, but rather by the subset of cards in the set uploaded so far. Even this may not be determinative (as there may be several clues which will allow a valid next card to be uploaded) and there may be a random or determined mechanism to provide choice between alternative valid clues. In this alternative, the information to provide these alternative clues is provided in memory tag 62, and the reward assembly application generates an appropriate clue to a valid further card based on knowledge of the content uploaded so far.

The customer then obtains the or a further card identified by the clue and uploads (step 75) the content from it into his computing device 65. The reward assembly application from the card runs (step 76), determining that file structure and some content for the appropriate set of cards already exists, and generating a clue for a further card that has not yet been uploaded. This process continues for each further card (step 77) until a clue is provided for the final card in the set. Once the content is uploaded from the final card in the set (step 78), the reward assembly application runs (step 79). It determines that the digital content from each card in the set is present, and that the digital reward can be generated. The reward assembly application then generates the digital reward—in this case, an encryption key—from the parts of the digital reward content obtained from the different collectable cards according to an algorithm within the reward assembly application (step 80). The customer is provided with an encryption key and an address—typically a URL—for obtaining the directly valuable reward. The customer accesses this URL (step 800) to obtain the reward. This could be a reward of digital media content, in which case it is downloaded directly (the advantage to the provider being the control of the digital content itself—rather than having it available in fragments on collectable cards). The reward could also be of discounts—in the form of vouchers or credits to a client account—for any good or service. The reward could even be of physical goods—the customer on presentation of the key may need to submit a delivery name and address to the provider.

A third embodiment of the invention is shown with respect to FIGS. 8, 9 and 10. In this embodiment, the physical products with which the memory tags are associated are examples a consumer product—in this specific case, boxes 81 of breakfast cereal (though it should be appreciated that the same approach could be applied for most packaged products). Where digital content is fixed to a staple consumer product in this way, providing content which is different for each product on the shelf may not be an ideal solution (having consumers attempt to choose between many cereal boxes with identical physical content is clearly inconvenient for retailer and customer) and a different model is used in this embodiment, involving the retailer providing the content for the memory tag 82, which is blank when cereal box 81 first physically obtained by the customer. The different phases involved are shown in FIG. 8. In phase A, the cereal boxes 81 are on the store shelves with empty memory tags 82—each product is at this point identical. In phase B, a cereal box 81 has been brought to checkout 83 for purchase. On purchase, the retailer runs a routine on their computing apparatus 84 to provide content for downloading to memory tag 82 through writer apparatus 85, in this case a stylus wirelessly connected to computing apparatus 84. In phase B, the customer has full possession of the cereal box 81 and uploads the digital content it contains to his computing device 86 (here again a PDA, purely by way of example) by way of reader apparatus 87, in this case a stylus connected and tethered by wire to PDA 86. As can be noted from the display of PDA 86, in this case the upload of content from the memory tag 82 provides a game to be played by the customer.

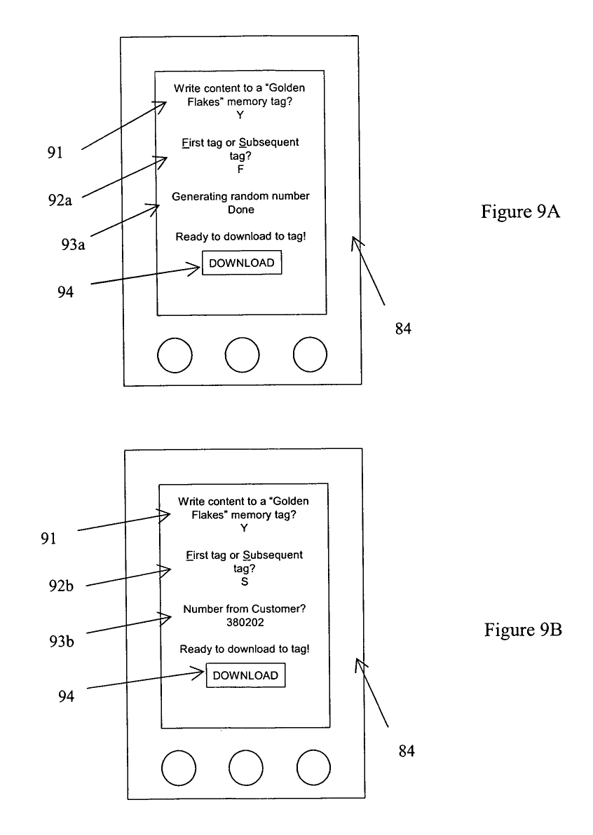

The processes of provision to the customer, and assembly by the customer, of a digital reward will now be described in more detail with reference to FIGS. 9A, 9, 10 and 11. Alternatives to specific steps described below will also be described.

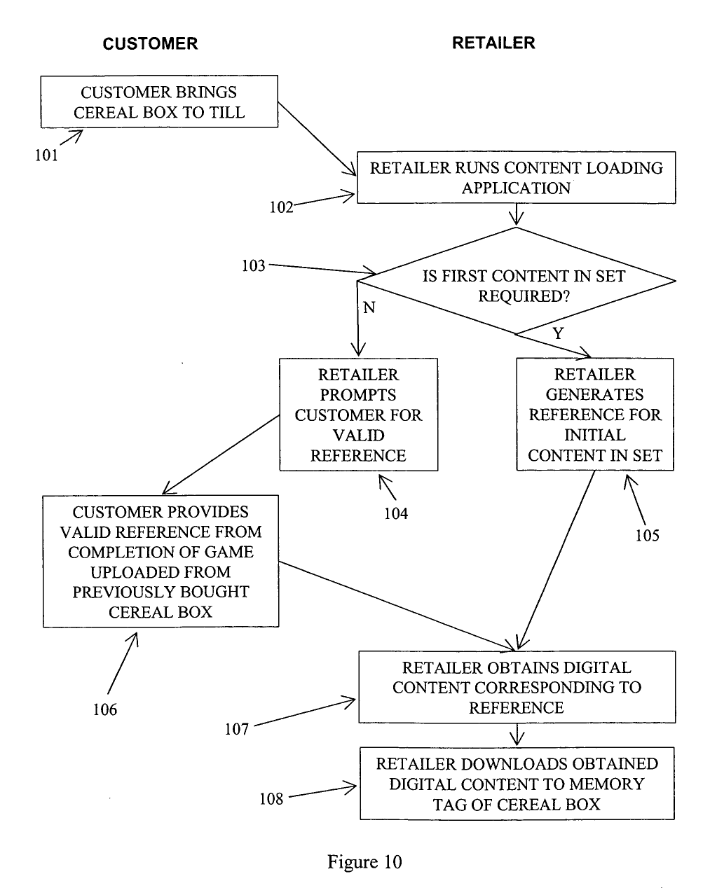

The provision to the customer of digital content providing parts of the digital reward is illustrated in the flow diagram of FIG. 10, with FIGS. 9A and 9B showing the different states of retailer computing apparatus 84 at different stages of the FIG. 10 process. The customer picks up one of the (at this point) identical cereal boxes 81 and brings it to the till or checkout of the retailer (step 101). When accepting the cereal box 81 for purchase, the retailer runs the content loading application on his computing apparatus 84 (step 102). The retailer needs to establish (by asking the customer) whether the first digital content in the set is required, or if the customer has already obtained digital content from a previously purchased cereal box (step 103). If the customer has not obtained previous digital content, the retailer generates a reference for initial content (step 105) in the digital content set (there may be only one such reference, a plurality of such references each relating to a different digital reward, or a plurality of such references in which a subset of the references each related to the same digital reward—any of these arrangements is possible). If the customer has already obtained digital content for that set, he will have received a reference (by a mechanism discussed below with reference to FIG. 11) for which the retailer prompts (step 104). The customer then provides the reference (step 106), which may be for example a password. Optionally, and not shown here, if there are different digital rewards available and the customer has already obtained a digital reward through this program, he may be provided with a reference to provide to the retailer to ensure that he is not given digital content leading to formation of the same digital reward.

If initial digital content is required, the screen of the retailer computing apparatus 84 may now appear as in FIG. 9A. The retailer has replied to a prompt 91 to write content to a memory tag, has established that initial content is required 92a, has generated a reference—in this case by means of a random number 93a. The final step is to provide (step 107) the digital content for downloading (step 108) to the memory tag 82, this being achieved by pressing a download button 94. Where subsequent content is required, the screen of the retailer computing apparatus is similar as shown in FIG. 9B, but as it has been identified that subsequent content is required 92b, the retailer is prompted for a reference number from the customer 93b before generating the content for download and providing the download button 94.

FIG. 11 shows how the customer collects digital content and assembles a digital reward. Once the customer has bought a cereal box with initial content (step 111) as described above, he then uploads the content from its memory tag to his computing apparatus (PC, PDA, cellular telephone or other suitable apparatus) (step 112) as shown in FIG. 8 (phase C). As for the other embodiments described, a reward assembly application (RAA) now runs (step 113)—advantageously, this is provided with the initial content loaded on to the memory tag of the first-purchased cereal box. The rest of the digital content provided on the memory tag consists of a part of the digital content for assembly of the digital reward (this may be a substantive part of the content for assembly into the digital reward, or simply digital content which allows the process of assembling the digital reward on the consumer's computing apparatus to continue, such as a reference which enables a next part of the digital content to be collected, as will be discussed further below) and content relating to the stage of digital reward collection. In this specific example, both are provided—a part of the digital reward content, and a reference to obtain the next digital content. This reference is not revealed directly to the customer. To obtain the reference, the customer must successfully complete a game provided to the customer when the RAA has run (step 114)—this game is provided is the content relating to the stage of digital reward collection. When the customer has completed the game (step 115), the RAA runs and determines whether the set of digital content obtained is complete and therefore contains all the parts necessary for assembly of the digital reward. If not, the RAA obtains the reference provided to obtain the next digital reward content (step 117) and the customer purchases a further cereal box and obtains the next digital content (step 118) by providing the retailer with the reference revealed by game completion as previously described with reference to FIGS. 9B and 10. If the set of digital content is complete, on completion of the final game (it may be expected that collection of digital content requires completion of a set of games of progressively greater difficulty) the RAA is enabled to assemble the digital reward from the digital content parts (step 119). In this case, as for the second embodiment, the digital reward is a key which can be used to obtain a reward from an indicated address (step 120)—whereas this address may be a URL as in the second embodiment, in the present case the preferable solution may simply be an address usable by the retailer to identify that the reward should be physically provided or otherwise credited to the customer.

It should be noted generally that where a digital reward is referred to in connection with embodiments of this invention, such a digital reward may be direct (of value in itself, such as digital media content) or indirect (of value only in what it can provide, such as an encryption key). Digital content parts are here considered as parts of a full set of digital content, all of which is needed for the digital reward to be provided.

Variants to this process are available within the scope of the claimed invention. In one such variant, only the final memory tag is provided with digital content actually forming the reward (this approach may be acceptable in this embodiment as dispensing of the content is under the retailer's direct control) and only the references to enable retrieval of the next digital content in the set is stored on individual tags. This has the advantage of relieving some burden on the storage requirements of the memory tag (as it is no longer necessary to provide substantive reward content and game content together) with the possible exception of the final game—this could be addressed by providing the final game in parts with memory tags of earlier bought cereal boxes, and assembling the final game and playing it before access to the digital reward is enabled.

1. A method of providing a digital reward comprising:
providing products with an attached digital memory;
downloading to the digital memory of each such product one digital content part from a set of digital content parts, the digital content parts of the set together defining the digital reward;
providing executable code which when executed by a suitable computing device uses the digital content parts of a set uploaded to that computing device to make the digital reward available to a user of the suitable computing device.

2. A method as claimed in claim 1, wherein the executable code is downloaded to the digital memory with at least one digital content part of the set of digital content parts.

3. A method as claimed in claim 2, wherein the executable code is downloaded to the digital memory with each digital content part of the set of digital content parts.

4. A method as claimed in claim 1, wherein the digital reward is obtained by compositing digital content from some or all of the digital content parts of the set.

5. A method as claimed in claim 1, wherein the digital reward is obtained by using at least a part of each digital content part to obtain a subsequent digital content part, the digital reward being derived from a final digital content part.

6. A method as claimed in claim 1, wherein the digital reward comprises digital media content.

7. A method as claimed in claim 1, wherein the digital reward comprises a key.

8. A method as claimed in claim 7, wherein the key is an encryption key.

9. A method as claimed in claim 7, further comprising providing an address for use of the key to make available a directly usable reward from the digital reward.

10. A method as claimed in claim 7, wherein the directly usable reward is a physical product or a service.

11. A method as claimed in claim 7, wherein the directly usable reward is a discount towards a physical product or a service.

12. A method as claimed in claim 7, wherein the directly usable reward is a credit to an account.

13. A method as claimed in claim 1, wherein the digital memory is comprised in a memory tag adapted to be written to and read from by contact or near contact with a reader.

14. A method as claimed in claim 13, wherein the memory tag is adapted to be written to and read from inductively.

15. A method as claimed in claim 1, wherein products carrying identified digital content parts of the set are detectable from the visual appearance of the product.

16. A method as claimed in claim 1, wherein a digital content part identifies by visual appearance one or more products carrying further digital content parts of the set.

17. A method as claimed in claim 1, wherein a digital content part identifies by reference one or more further digital content parts of the set.

18. A method as claimed in claim 17, wherein downloading to the digital memory of a product one digital content part from the set of digital content parts takes place on purchase of a product.

19. A method as claimed in claim 18, wherein on provision of the reference identifying a further digital content part of the set, that digital content part is downloaded to the digital memory on purchase of the product.

20. A method as claimed in claim 16, wherein identification is determined by the most recently uploaded digital content part of the set.

21. A method as claimed in claim 16, wherein identification is determined by the subset of the digital content parts of the set so far uploaded.

22. A method as claimed in claim 16, wherein identification is not provided until a task provided by the most recently uploaded digital content part is completed.

23. A method as claimed in claim 22, wherein the task is solving a clue provided in the most recently uploaded digital content part.

24. A method as claimed in claim 22, wherein the task is successfully completing a game provided in the most recently uploaded digital content part.

25. A data carrier having recorded thereon digital content, the digital content comprising a digital content part of a set of digital content parts, the digital content part comprising an identifier to identify at least one further digital content part of the set.

26. A data carrier as claimed in claim 25, the digital content further comprising application software executable on a suitable computing device to identify to a user the at least one further digital content part of the set.

27. A data carrier as claimed in claim 26, the application software on execution on a suitable computing device providing a task to a user, completion of the task by the user being sufficient to identify to a user the at least one further digital content part of the set.

28. A data carrier as claimed in claim 27, the application software providing a game, completion of the task comprising successful completion of the game.

29. A data carrier as claimed in claim 25, the digital content further comprising application software executable on a suitable computing device to produce the digital reward on uploading of all the digital content parts of the set on to the suitable computing device.

30. A data carrier as claimed in claim 25 in the form of a passive memory circuit comprising a digital memory.

31. A data carrier as claimed in claim 30 wherein the passive memory circuit is adapted to be inductively powered, read from and written to by radio frequency radiation.

32. A collectable or game card comprising a passive memory circuit comprising a digital memory having stored therein digital content, the digital content comprising a digital content part of a set of digital content parts, the digital content part comprising an identifier to identify at least one further digital content part of the set.

33. A collectable or game card as claimed in claim 32 where the identifier is a visual representation of a further collectable or game card containing in its passive memory circuit the at least one further digital content part of the set.

34. A consumer product comprising a passive memory circuit comprising a digital memory having stored therein digital content, the digital content comprising a digital content part of a set of digital content parts, the digital content part comprising an identifier to identify at least one further digital content part of the set.

35. A consumer product as claimed in claim 34 where the identifier is a reference designating the at least one further digital content part of the set.
